(19) United States
(12) Patent Application Publication
(10) Pub. No.: US 2010/0115727 A1
(43) Pub. Date: May 13, 2010

(54) DUST-COLLECTING APPARATUS AND CLEANER HAVING THE SAME

(76) Inventor: Jang-keun OH, Gwangju-city (KR)

Correspondence Address: North Star Intellectual Property Law, PC, P.O. Box 34688, Washington, DC, 20043, US

(21) Appl. No.: 12/579,953

(22) Filed: Oct. 15, 2009

(30) Foreign Application Priority Data
Nov. 7, 2008 (KR) 10-2008-0110434

(51) Int. Cl. A47L 9/16; B01D 45/16

(52) U.S. Cl. 15/347; 96/416

(57) ABSTRACT

A cyclone dust-collecting apparatus is provided. The apparatus may includes a cyclone chamber configured to separate dust from air which is drawn in along with the dust, a dust receptacle configured to store the dust separated by the cyclone chamber, a transparent case configured to surround the cyclone chamber and the dust receptacle, and a colored guide unit configured to form a spiral passage so that a whirling air current is formed in the cyclone chamber.

### CROSS-REFERENCE TO RELATED APPLICATION

This application claims the benefit under 35 U.S.C. §119(a) of a Korean Patent Application No. 10-2008-0110434, filed on Nov. 7, 2008, in the Korean Intellectual Property Office, the entire disclosure of which is incorporated herein by reference for all purposes.

### BACKGROUND

1. Field

The following description relates to a dust-collecting apparatus, and more particularly, to a cyclone dust-collecting apparatus and a cleaner having the cyclone dust-collecting apparatus.

2. Description of the Related Art

Cleaners may generally include dust-collecting apparatuses to separate dust from air which is drawn in along with the dust. Conventionally, filters have become widely used as dust-collecting apparatuses. However, since dust-collecting performance of filters is reduced as the use time of the cleaners increases, users need to regularly replace the filters. This may be inconvenient to the users.

Dust-collecting apparatuses to which a cyclone method may be applied are being developed, and may be referred to as ‘cyclone dust-collecting apparatuses.’ In the cyclone method, dust is separated from dust-laden air using a centrifugal force generated by making air whirl inside the dust-collecting apparatuses. Such cyclone dust-collecting apparatuses may be used semi-permanently, and thus the need to regularly replace filters is reduced or eliminated.

If relatively large and heavy dust particles flow in a cyclone dust-collecting apparatus, these large dust particles often block passages formed in the cyclone dust-collecting apparatus, and thus the cyclone dust-collecting apparatus may not be fully operable. This problem may occasionally occur in a passage with a smaller dimension than other passages formed in the cyclone dust-collecting apparatus. Since passages are formed in the cyclone dust-collecting apparatus, it is difficult for users to check whether or not passages are blocked, without disassembling the cyclone dust-collecting apparatus.

### SUMMARY

In one general aspect, there is provided a cyclone dust-collecting apparatus which may include a cyclone chamber configured to separate dust from air which is drawn in along with the dust, a dust receptacle configured to store the dust separated by the cyclone chamber, a transparent case configured to surround the cyclone chamber and the dust receptacle, and a colored guide unit configured to form a spiral passage so that a whirling air current is formed in the cyclone chamber.

The colored guide unit may include a discharge pipe configured to allow air, from which the dust is separated by the cyclone chamber, to be discharged, and a spiral blade configured to be disposed on an outer circumference of the discharge pipe to form the spiral passage.

The colored guide unit may further include a connection portion configured to be in contact with the transparent case so that the colored guide unit is stably fixed to the transparent case.

The discharge pipe and the spiral blade may protrude further than the connection portion.

The spiral passage may be rotated at an angle more than 360° and less than 720°.

The cyclone chamber may be disposed horizontally above the dust receptacle.

The cyclone dust-collecting apparatus may further include a second cyclone chamber arranged side by side to the cyclone chamber.

A dust discharge portion may be formed on a first side of the cyclone chamber, and the colored guide unit may be connected to a second side of the cyclone chamber.

A bottom plate may be configured to be openably/closably connected to a lower side of the transparent case.

An inlet may be configured to allow dust-laden air drawn in from outside to flow into the cyclone dust-collecting apparatus, and a connection passage may be configured to connect the inlet to the colored guide unit.

In another aspect, there is provided a cleaner which may include a suction brush configured to draw in air along with dust from a surface being cleaned, a cyclone dust-collecting apparatus configured to separate dust from the air drawn in through the suction brush, and a main body to which the cyclone dust-collecting apparatus is mounted, The cyclone dust-collecting apparatus may include a cyclone chamber configured to separate dust from air which is drawn in along with the dust, a dust receptacle configured to store the dust separated by the cyclone chamber, a transparent case configured to surround the cyclone chamber and the dust receptacle, and a colored guide unit configured to form a spiral passage so that a whirling air current may be formed in the cyclone chamber.

In another aspect, a cyclone dust-collecting apparatus is provided which may include a transparent case, a cyclone chamber, a dust receptacle, and a colored guide unit. The colored guide unit may be positioned within the transparent case and the transparent case may enclose the cyclone chamber and the dust receptacle. The dust receptacle may be in communication with the cyclone chamber.

The cyclone chamber may be bounded by the transparent case and the colored guide unit.

The cyclone dust-collecting apparatus may be configured to be removably attachable to a main body of a cleaner.

Other features and aspects will be apparent from the following detailed description, the drawings, and the claims.

### BRIEF DESCRIPTION OF THE DRAWINGS

FIG. 1 is a perspective view of an exemplary cleaner.

FIG. 2 is a perspective view of an exemplary cyclone dust-collecting apparatus shown in FIG. 1.

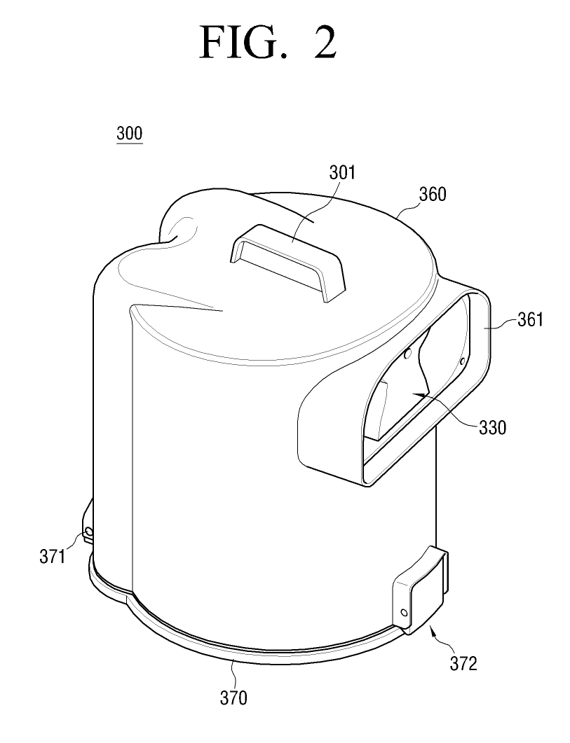

FIG. 3 is an exploded, perspective view of the exemplary cyclone dust-collecting apparatus shown in FIG. 2.

FIG. 4 is a partial cut-away view of the exemplary cyclone dust-collecting apparatus shown in FIG. 2.

FIG. 5 is a cross-sectional view of the exemplary cyclone dust-collecting apparatus shown in FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to the those of ordinary skill in the art. Also, descriptions of well-known functions and constructions may be omitted for increased clarity and conciseness.

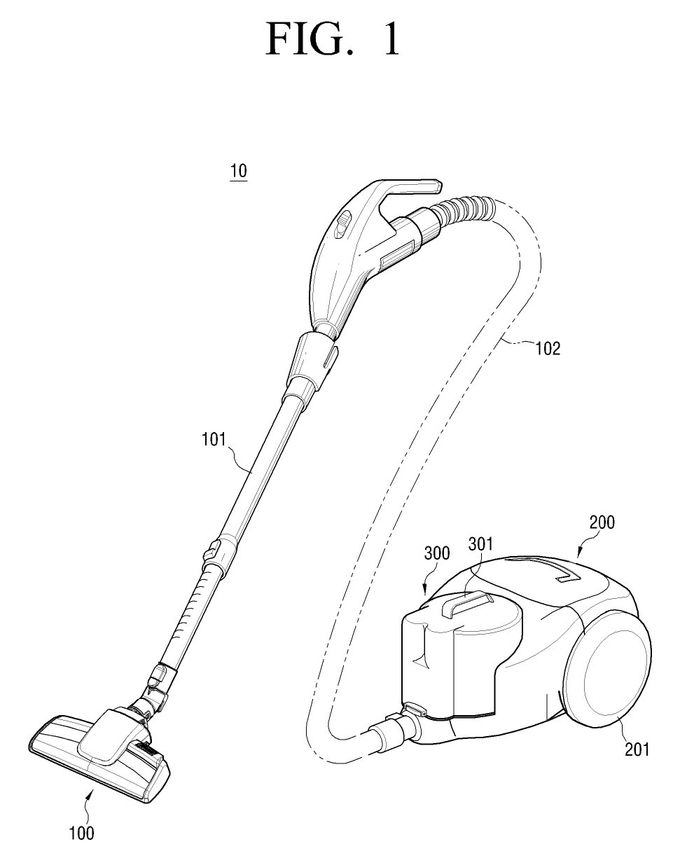

FIG. 1 illustrates an exemplary cleaner 10. The cleaner 10 includes a suction brush 100, a main body 200, and a cyclone dust-collecting apparatus 300. The cleaner 10 may be a canister type cleaner in which the suction brush 100 is detached from the main body 200, for example, as illustrated in FIG. 1. However, the cleaner 10 is not limited to this type. Accordingly, the following disclosure may be equally applicable to an upright type cleaner in which the suction brush 100 may be formed integrally with the main body 200, for example.

The suction brush 100 may draw in air containing dust, dirt and so on (also referred to as dust-laden air) from a surface being cleaned. The dust-laden air drawn in through the suction brush 100 may be transferred to the main body 200 through a brush pipe 101 and a suction hose 102.

The main body 200 may include a motor (not shown), which may be disposed therein and is capable of generating a suction force. Additionally, the main body 200 may include a pair of wheels 201 to facilitate movement of the main body 200.

The cyclone dust-collecting apparatus 300 may separate dust from the dust-laden air drawn in through the suction brush 100, and may be detachably mounted to the main body 200. The cyclone dust-collecting apparatus 300 may include a handle 301 with which a user may attach or detach the cyclone dust-collecting apparatus 300 to or from the main body 200. To use the cleaner 10, a user may connect the cyclone dust-collecting apparatus 300 to the main body 200. If a large amount of dust is collected in the cyclone dust-collecting apparatus 300, the user may separate the cyclone dust-collecting apparatus 300 from the main body 200 and remove the dust from the cyclone dust-collecting apparatus 300.

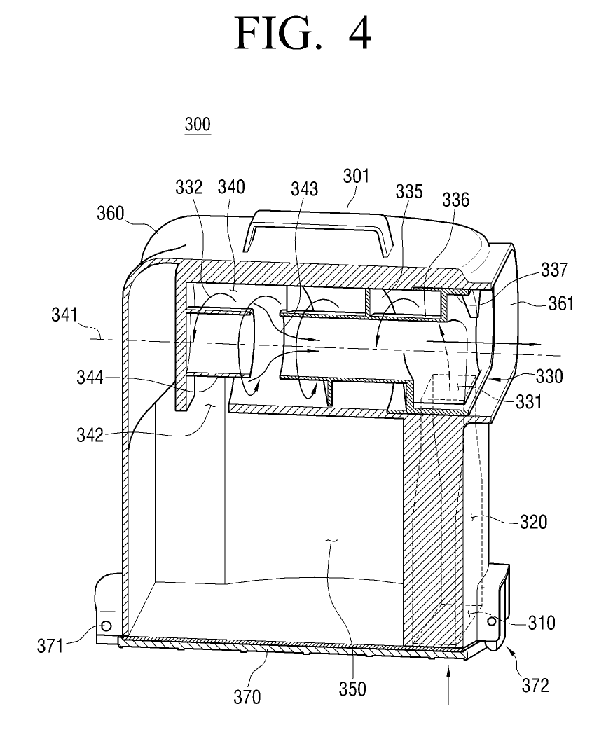

The dust-laden air passing through the suction hose 102 may flow in the cyclone dust-collecting apparatus 300 through a flow passage (not shown) formed inside the main body 200. Air from which dust is separated by the cyclone dust-collecting apparatus 300 may be discharged outside the main body 200, and the dust separated from the dust-laden air may be collected in a dust receptacle 350 (see FIG. 4) of the cyclone dust-collecting apparatus 300.

Referring to FIG. 4, the exemplary cyclone dust-collecting apparatus 300 may include an inlet 310, a connection passage 320, a colored guide unit 330, a cyclone chamber 340, the dust receptacle 350, a transparent case 360 and a bottom plate 370.

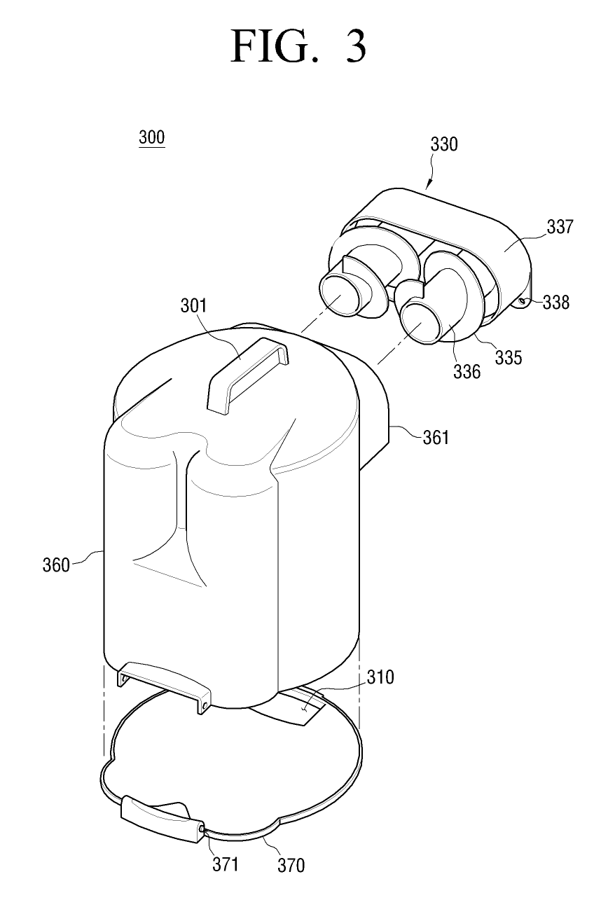

The inlet 310 enables the dust-laden air drawn in through the suction brush 100 to flow into the cyclone dust-collecting apparatus 300. Referring to FIGS. 3 and 4, the inlet 310 may be formed on a bottom surface of the cyclone dust-collecting apparatus 300, that is, on the bottom plate 370, but there is no limitation thereto. Accordingly, the inlet 310 may be formed at any position other than the bottom plate 370.

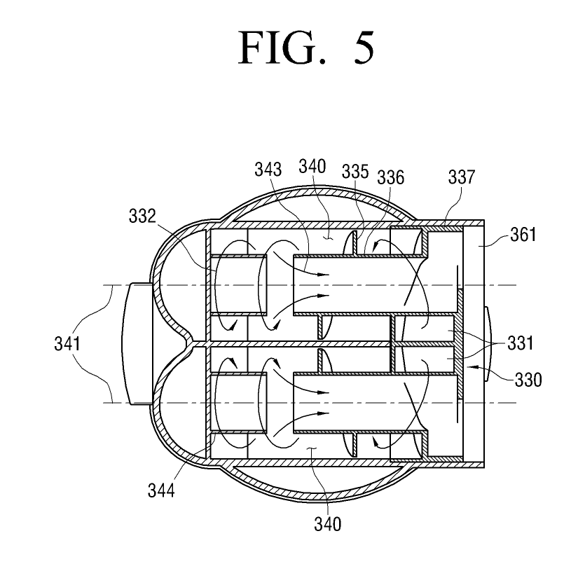

The connection passage 320 may connect the inlet 310 to the colored guide unit 330, as shown in FIG. 4, for example. The dust-laden air flowing into the cyclone dust-collecting apparatus 300 may enter the colored guide unit 330 through an opening 331 of the colored guide unit 330 along the connection passage 320. Additionally, two cyclone chambers 340 and two openings 331 may be formed on the colored guide unit 330, as shown in FIG. 5, for example. The dust-laden air flowing into the cyclone dust-collecting apparatus 300 may be divided, and may then flow into the two cyclone chambers 340, respectively.

The colored guide unit 330 may form a spiral passage as shown in FIGS. 3 to 5, for example, to allow air to whirl in the cyclone chamber 340. In other words, a whirling air current may be formed within the cyclone chamber 340 in a direction indicated by an arrow 332 shown in FIGS. 4 and 5, for example.

The colored guide unit 330 may be made of colored materials. The transparent case 360 enclosing the cyclone chamber 340 may be made of transparent materials, so that a user may observe the colored guide unit 330 within the transparent case 360, thereby increasing visibility. Additionally, the user may monitor air and dust flowing along the spiral passage formed by the colored guide unit 330.

The colored guide unit 330 may include a pair of spiral blades 335, a pair of discharge pipes 336 and a connection portion 337.

The pair of spiral blades 335 may form a spiral passage as shown in FIGS. 3 to 5, for example. The pair of spiral blades 335 may be formed on outer circumferences of the pair of discharge pipes 336. Dust-laden air may flow along the spiral passage, and thus a whirling air current may be formed in the cyclone chamber 340. In this example, the spiral passage may desirably be rotated at an angle more than 360° and less than 720°.

The pair of discharge pipes 336 may allow air from which dust is separated to be discharged from the cyclone chamber 340. This process is further described below.

When the colored guide unit 330 is assembled with the transparent case 360, the connection portion 337 may come into contact with the transparent case 360. In other words, the connection portion 337 may have a shape corresponding to a colored guide unit mounting portion 361 which is formed in the transparent case 360. Accordingly, the colored guide unit 330 may be stably fixed to the transparent case 360. As shown in FIG. 3, for example, a screw hole 338 may be formed on the colored guide unit 330, and accordingly a screw may be fitted in the screw hole 338 so that the colored guide unit 330 may be coupled to the transparent case 360.

The pair of spiral blades 335 and pair of discharge pipes 336 may protrude further than the connection portion 337. In this example, a user can also monitor air and dust whirling in a region where the pair of spiral blades 335 and pair of discharge pipes 336 protrude further than the connection portion 337 through the transparent case 360. If relatively large and heavy dust particles flow in the cyclone dust-collecting apparatus 300, these large dust particles may block passages formed in the cyclone dust-collecting apparatus 300. This may occur in a passage with a smaller dimension than other passages of the cyclone dust-collecting apparatus 300. For example, this may occur in the spiral passage which is formed by the pair of spiral blades 335. However, it is possible to check whether or not the spiral passage with a small dimension formed by the pair of spiral blades 335 is blocked, through the transparent case 360.

The cyclone chamber 340 may separate dust from dust-laden air using a centrifugal force. When a whirling air current is formed in the direction indicated by the arrow 332 shown in FIGS. 4 and 5, for example, dust which is greater in weight than air may be moved by the centrifugal force in a radial direction from a central axis 341 of the cyclone chamber 340, and may then be discharged through a dust discharge port 342. Air from which the dust is separated may be discharged outside the main body 200 through the pair of discharge pipes 336 in a direction indicated by an arrow 343, and may then be discharged via a passage (not shown).

The cyclone chamber 340 may include a guide pipe 344 disposed on a first side thereof. The guide pipe 344 may guide the whirling air current formed in the cyclone chamber 340. As the whirling air current moves from right to left as shown in FIGS. 4 and 5, for example, the whirling intensity of the air may gradually decrease. In this situation, the guide pipe 344 may function to increase the whirling intensity of the air.

The cyclone chamber 340 may be disposed horizontally above the dust receptacle 350. As described above, a user may monitor the operating status of the cyclone chamber 340 through the transparent case 360 enclosing the cyclone chamber 340.

The cyclone chamber 340 may be cylindrical in shape, but it is not limited thereto. Accordingly, the shape of the cyclone chamber 340 may have various shapes other than the cylindrical shape, for example a cone shape.

Additionally, two cyclone chambers 340 may be provided, as shown in FIG. 5, for example. However, the number of cyclone chambers 340 is not limited to this number. Accordingly, the number and the arrangement of cyclone chambers 340 may be changed according to the implementations.

Furthermore, the dust discharge port 342 may be formed on the first side of the cyclone chamber 340 as shown in FIG. 4, for example, and the colored guide unit 330 may be connected to a second side of the cyclone chamber 340. However, the position of the dust discharge port 342 and the connection position of the colored guide unit 330 may be changed according to the arrangement of the cyclone chamber 340.

The dust receptacle 350 may store dust separated by the cyclone chamber 340. The dust separated by the cyclone chamber 340 may flow into the dust receptacle 350 through the dust discharge port 342.

The transparent case 360 may surround the cyclone chamber 340 and the dust receptacle 350, and may be made of transparent materials. Thus, it is possible for a user to monitor the operating status of the cyclone chamber 340 and the colored guide unit 330, and to check an amount of dust stored in the dust receptacle 350.

The bottom plate 370 may be openably/closably connected to a lower side of the transparent case 360. For example, a hinge axis 371 may be used to connect the bottom plate 370 to the transparent case 360. In this situation, a plate fixing unit 372 disposed on the lower side of the transparent case 360 may fix the bottom plate 370 to the transparent case 360.

Since the transparent case 360 may be made of transparent materials, a user can check the amount of dust contained in the dust receptacle 350, as described above. If the dust receptacle 350 is full of dust, a user may separate the cyclone dust-collecting apparatus 300 from the main body 200, open the bottom plate 370, and remove the dust from the dust receptacle 350.

A number of exemplary embodiments have been described above. Nevertheless, it will be understood that various modifications may be made. For example, suitable results may be achieved if the described techniques are performed in a different order and/or if components in a described system or apparatus are combined in a different manner and/or replaced or supplemented by other components or their equivalents. Accordingly, other implementations are within the scope of the following claims.

What is claimed is:

1. A cyclone dust-collecting apparatus comprising:
a cyclone chamber configured to separate dust from air which is drawn in along with the dust;
a dust receptacle configured to store the dust separated by the cyclone chamber;
a transparent case configured to surround the cyclone chamber and the dust receptacle; and
a colored guide unit configured to form a spiral passage so that a whirling air current is formed in the cyclone chamber.

2. The cyclone dust-collecting apparatus of claim 1, wherein the colored guide unit comprises:
a discharge pipe configured to allow air, from which the dust is separated by the cyclone chamber, to be discharged; and
a spiral blade configured to be disposed on an outer circumference of the discharge pipe to form the spiral passage.

3. The cyclone dust-collecting apparatus of claim 2, wherein the colored guide unit further comprises:
a connection portion configured to be in contact with the transparent case so that the colored guide unit is stably fixed to the transparent case.

4. The cyclone dust-collecting apparatus of claim 3, wherein the discharge pipe and the spiral blade protrude further than the connection portion.

5. The cyclone dust-collecting apparatus of claim 1, wherein the spiral passage is rotated at an angle more than 360° and less than 720°.

6. The cyclone dust-collecting apparatus of claim 1, wherein the cyclone chamber is disposed horizontally above the dust receptacle.

7. The cyclone dust-collecting apparatus of claim 6, further comprising a second cyclone chamber arranged side by side to the cyclone chamber.

8. The cyclone dust-collecting apparatus of claim 1, wherein a dust discharge portion is formed on a first side of the cyclone chamber, and the colored guide unit is connected to a second side of the cyclone chamber.

9. The cyclone dust-collecting apparatus of claim 1, further comprising:
a bottom plate configured to be openably/closably connected to a lower side of the transparent case.

10. The cyclone dust-collecting apparatus of claim 1, further comprising:
an inlet configured to allow dust-laden air drawn in from outside to flow into the cyclone dust-collecting apparatus; and
a connection passage configured to connect the inlet to the colored guide unit.

11. A cleaner comprising:
a suction brush configured to draw in air along with dust from a surface being cleaned;
a cyclone dust-collecting apparatus configured to separate dust from the air drawn in through the suction brush; and
a main body to which the cyclone dust-collecting apparatus is mounted,
wherein the cyclone dust-collecting apparatus comprises:
a cyclone chamber configured to separate dust from air which is drawn in along with the dust;
a dust receptacle configured to store the dust separated by the cyclone chamber;
a transparent case configured to surround the cyclone chamber and the dust receptacle; and
a colored guide unit configured to form a spiral passage so that a whirling air current is formed in the cyclone chamber.

12. A cyclone dust-collecting apparatus comprising:
a transparent case;
a cyclone chamber;
a dust receptacle; and a colored guide unit;
wherein the colored guide unit is positioned within the transparent case and the transparent case encloses the cyclone chamber and the dust receptacle; and
wherein the dust receptacle is in communication with the cyclone chamber.

13. The cyclone dust-collecting apparatus of claim 12, wherein the cyclone chamber is bounded by the transparent case and the colored guide unit.

14. The cyclone dust-collecting apparatus of claim 12, wherein the cyclone dust-collecting apparatus is configured to be removably attachable to a main body of a cleaner.
